(19) United States
(12) Patent Application Publication
(10) Pub. No.: US 2019/0332877 A1
(43) Pub. Date: Oct. 31, 2019

(54) BIOMETRIC AUTHENTICATION DEVICE AND RECORDING MEDIUM

(71) Applicant: SHARP KABUSHIKI KAISHA, Sakai City, Osaka (JP)

(72) Inventor: TAKAYOSHI NOSE, Sakai City (JP)

(21) Appl. No.: 16/344,727

(22) PCT Filed: Aug. 9, 2017
(86) PCT No.: PCT/JP2017/028938

§ 371 Date: Apr. 24, 2019

(30) Foreign Application Priority Data
Nov. 18, 2016 (JP) 2016-225455

(51) Int. Cl. G06K 9/00

(52) U.S. Cl. CPC G06K 9/00919; G06K 9/00604; G06K 9/00255

(57) ABSTRACT

To improve the usability during biometric authentication, a biometric authentication device (100) includes: an image sensing section (101) configured to capture a biometric authentication image of a part of a living body; a display section (107) configured to display a guide image among a plurality of guide images for aligning the part of the living body and the image sensing section (101) with each other in order for the image sensing section (101) to capture the biometric authentication image; and a control section (110) configured to carry out authentication on a basis of the biometric authentication image, the control section (110) being configured to cause the display section (107) to display one of the plurality of guide images on a basis of at least either (i) an authentication accuracy corresponding to application software configured to operate in accordance with a result of the authentication or (ii) image sensing environment information related to the capturing, the plurality of guide images at least including (i) a first guide image for aligning the part of the living body and the image sensing section with each other at such respective positions that the part of the living body and the image sensing section are separated from each other by a first distance and (ii) a second guide image for aligning the part of the living body and the image sensing section with each other at such respective positions that the part of the living body and the image sensing section are separated from each other by a second distance smaller than the first distance.

### TECHNICAL FIELD

An aspect of the present invention relates to a biometric authentication device and a biometric authentication program.

### BACKGROUND ART

There has been known a method used in a face authentication system (that is, an authentication system involving recognizing a person's face of which an image has been captured with a camera) to output an audio or image guidance so that the size of the face in the camera-captured image is a predetermined size suitable for authentication. Patent Literature 1, for example, discloses a guidance method that includes (i) displaying a template for deciding on the face position and (ii) superimposing over the template an image of the face of an authentication target which image is to be captured by an image sensing section.

Portable terminals such as a smartphone use a biometric authentication technique involving use of a camera such as eye-white authentication and face authentication for such purposes as electronic payment and terminal unlocking.

### CITATION LIST

### Patent Literature

[Patent Literature 1] Japanese Patent Application Publication, Tokukai, No. 2012-133477 (Publication Date: Jul. 12, 2012)

### SUMMARY OF INVENTION

### Technical Problem

A portable terminal is used in various environments, and may be required to carry out high-accuracy authentication in, for example, a dark place. Conventional art is thus configured such that in a case where a portable terminal uses a biometric authentication technique, the user needs to bring the user's face near the camera in such a manner that the face is shown on the camera screen with a large size for authentication so that the authentication accuracy is not decreased even in a case where the area surrounding the user is dark. This utilizes a common property of a camera that capturing an image of an object with the object closer to the camera allows a higher definition image to be obtained. The posture of the user when the user has brought the user's face near the camera, however, differs greatly from the posture of the user when the user normally operates the portable terminal. Thus, a portable terminal that uses a conventional biometric authentication technique requires the user to change the posture to bring the user's face near the camera each time of authentication. This unfortunately impairs the usability.

An aspect of the present invention has been accomplished in view of the above issue. It is an object of the aspect of the present invention to provide, for example, a biometric authentication device having usability for biometric authentication which usability has been improved over conventional art.

### Solution to Problem

In order to attain the above object, a biometric authentication device in accordance with an aspect of the present invention includes: an image sensing section configured to capture a biometric authentication image of a part of a living body; a display section configured to display a guide image among a plurality of guide images for aligning the part of the living body and the image sensing section with each other in order for the image sensing section to capture the biometric authentication image; and a control section configured to carry out authentication on a basis of the biometric authentication image, the control section being configured to cause the display section to display one of the plurality of guide images on a basis of at least either (i) an authentication accuracy corresponding to application software configured to operate in accordance with a result of the authentication or (ii) image sensing environment information related to the capturing, the plurality of guide images at least including (i) a first guide image for aligning the part of the living body and the image sensing section with each other at such respective positions that the part of the living body and the image sensing section are separated from each other by a first distance and (ii) a second guide image for aligning the part of the living body and the image sensing section with each other at such respective positions that the part of the living body and the image sensing section are separated from each other by a second distance smaller than the first distance.

### Advantageous Effects of Invention

An aspect of the present invention allows the user to change the holding posture only when it is necessary to do so, and thereby advantageously improves the usability during biometric authentication over conventional art.

### BRIEF DESCRIPTION OF DRAWINGS

FIG. 1 is a block diagram illustrating the functional configuration of a biometric authentication device in accordance with Embodiment 1 of the present invention.

FIG. 2 is a flowchart illustrating a process carried out by the biometric authentication device in accordance with Embodiment 1 of the present invention.

FIG. 3 provides diagrams each as an example output image of the biometric authentication device in accordance with Embodiment 1 of the present invention.

FIG. 4 is a block diagram illustrating the functional configuration of a biometric authentication device in accordance with Embodiment 2 of the present invention.

FIG. 5 is a flowchart illustrating a process carried out by the biometric authentication device in accordance with Embodiment 2 of the present invention.

FIG. 6 is a block diagram illustrating the functional configuration of a biometric authentication device in accordance with Embodiment 3 of the present invention.

FIG. 7 is a flowchart illustrating a process carried out by the biometric authentication device in accordance with Embodiment 3 of the present invention.

FIG. 8 is a hardware block diagram illustrating an example configuration of the biometric authentication device in accordance with Embodiment 1 of the present invention.

FIG. 9 is an example of a comparison table that shows a correspondence between the illuminance range, the number of pixels for the eye width with which number authentication is possible, and the size of the guide image displayed.

FIG. 10 is an example of a comparison table that shows a correspondence between the authentication accuracy, the number of pixels for the eye width with which number authentication is possible, and the size of the guide image displayed.

### DESCRIPTION OF EMBODIMENTS

### Embodiment 1

The following description will specifically discuss, with reference to drawings, a biometric authentication device 100 in accordance with Embodiment 1 of the present invention.

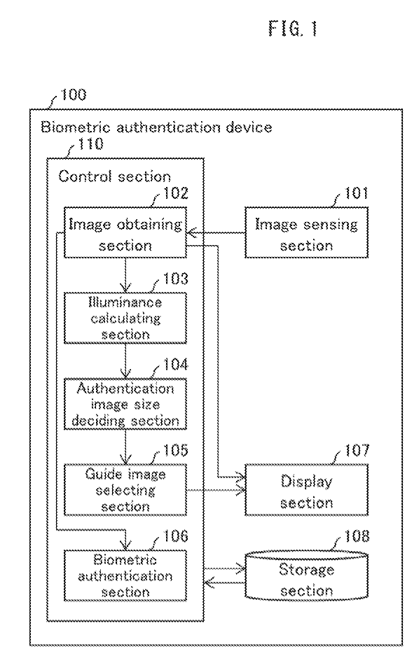

FIG. 1 is a block diagram illustrating the functional configuration of a biometric authentication device 100 in accordance with Embodiment 1 of the present invention. The biometric authentication device 100 is a biometric authentication device for carrying out biometric authentication (hereinafter referred to simply as “authentication” as well) with use of a biometric authentication image captured of a portion of a living body as an authentication site. The biometric authentication device 100 includes an image sensing section 101, a display section 107, a storage section 108, and a control section 110.

The control section 110 centrally controls the biometric authentication device 100. In the biometric authentication device 100, the control section 110 functions as an image obtaining section 102, an illuminance calculating section 103, an authentication image size deciding section 104, a guide image selecting section 105, and a biometric authentication section 106. The image obtaining section 102 causes the image sensing section 101 to capture an illuminance calculation image for use in illuminance value calculation. The illuminance calculating section 103 calculates an illuminance value from the illuminance calculation image. The authentication image size deciding section 104 determines the possibility of authentication, more specifically, whether it is possible to capture a biometric authentication image having a definition that allows authentication. The authentication image size deciding section 104 also decides on an image size that allows authentication (that is, the size of an authentication site in the biometric authentication image). The guide image selecting section 105 causes the display section 107 to display a guide image corresponding to the image size. The biometric authentication section 106 carries out authentication with use of the biometric authentication image captured. A later description will detail processes carried out by the above sections.

The display section 107 displays an image. The display section 107 is, for example, a display device such as a liquid crystal display (LCD) and an organic EL display (OLED). The image sensing section 101 captures an image, and is capable of capturing either a moving image or a still image. The image sensing section 101 may be capable of capturing a still image only. An image captured by the image sensing section 101 is stored in the storage section 108. The image sensing section 101 is, for example, a camera.

(1) Outline of Biometric Authentication Device 100

The biometric authentication device 100 carries out a step of, when the image sensing section 101 is held in a normal posture (first holding posture), determining whether it is possible to capture a biometric authentication image having a definition that allows authentication. The biometric authentication device 100, on the basis of the result of the determining step, selects a single guide image from among guide images having respective sizes different from one another, and causes the display section 107 to display the guide image selected. Specifically, the biometric authentication device 100, in a case where the biometric authentication device 100 has determined during the determining step that it is possible to capture a biometric authentication image having a definition that allows authentication, carries out a step of causing the display section 107 to display a guide image (hereinafter referred to as “first guide image”) for aligning an authentication site and the image sensing section 101 with each other in the normal posture. The biometric authentication device 100, in a case where the biometric authentication device 100 has determined during the determining step that it is impossible to capture a biometric authentication image having a definition that allows authentication, carries out a step of causing the display section 107 to display a guide image (hereinafter referred to as “second guide image”) for aligning an authentication site and the image sensing section 101 with each other in a special posture (second holding posture), in which the distance between an authentication site and the image sensing section 101 is smaller than in the normal posture). The biometric authentication device 100 may determine, on the basis of at least either (i) the authentication accuracy suitable for application software that operates in accordance with the authentication result or (ii) image sensing environment information related to image sensing, whether it is possible to capture a biometric authentication image having a definition that allows authentication.

The second guide image is larger in size than the first guide image (details described later). The term “size” refers to the size of a region in a display screen displayed by the display section 107. The “biometric authentication image” is an image captured by the image sensing section 101, and at least includes an authentication site image. The “authentication site” is a part of the body of the user for use in biometric authentication.

The biometric authentication device 100 is arranged such that (i) in a case where authentication is possible in the normal posture, the user carries out alignment in the current posture on the basis of the first guide image to capture a biometric authentication image for authentication and that (ii) in a case where authentication is impossible in the normal posture, the user changes the posture to the special posture, carries out alignment on the basis of the second guide image, and captures a biometric authentication image for authentication. This allows the user to change the posture to the special posture only in a case where it is necessary to do so for authentication, and thus minimizes authentication in the special posture. This in turn prevents the usability from decreasing due to a change of the holding posture, and allows a highly reliable authentication process to be carried out.

The biometric authentication device 100 is not limited to any particular terminal device. Examples include a portable terminal such as a smartphone. In a case where the biometric authentication device 100 is in the form of a portable terminal, which is used for purposes other than biometric authentication (for example, a browser and a game), the user, unlike with conventional art, does not need to change the holding posture each time authentication is to be carried out. This improves continuity between an operation of the portable terminal for a purpose other than biometric authentication and an operation for biometric authentication. This in turn allows the usability for biometric authentication to be improved significantly in a case where the biometric authentication device 100 is in the form of a portable terminal, which is used for a purpose other than biometric authentication as well.

(2) Example Biometric Authentication Process

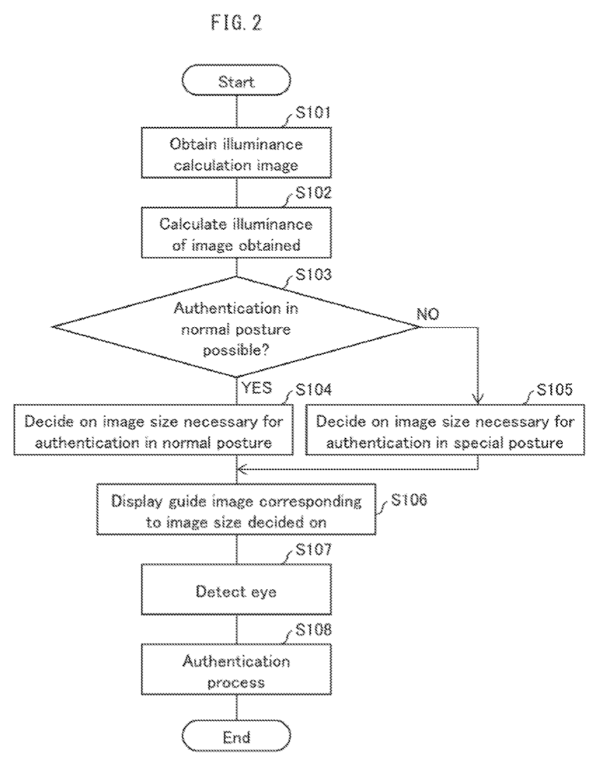

The following description will discuss, with reference to FIGS. 1 and 2, an example biometric authentication process carried out by the biometric authentication device 100. FIG. 2 is a flowchart illustrating a process carried out by the biometric authentication device 100 in accordance with Embodiment 1 of the present invention.

Known examples of biometric authentication techniques include eye-white authentication, face authentication, and iris authentication. Embodiment 1 involves eye-white authentication as an example biometric authentication technique. The term “eye-white authentication” refers to a technique of extracting features from a vein in the white of an eye for authentication (see, for reference, http://techable.jp/archives/17318 on the internet [retrieved on Sep. 29, 2016]). A more colorful image of the eye for use in authentication leads to a larger amount of information on veins and thus ensures a higher authentication accuracy. In Embodiment 1, a part of the body of the user for use in biometric authentication (authentication site) is thus an eye of the user's, and the “biometric authentication image” is an image captured by the image sensing section 101 and having a portion that shows an eye.

Embodiment 1 involves an example in which whether it is possible to capture a biometric authentication image having a definition that allows authentication is determined on the basis of image sensing environment information related to image sensing. The “image sensing environment information related to image sensing” refers to, for example, information indicative of an environment in which image sensing for biometric authentication is carried out, and is information based on illuminance, for example. Embodiment involves an example in which the “image sensing environment information related to image sensing” is an illuminance value calculated from an illuminance calculation image. The “illuminance calculation image” is an image that is captured by the image sensing section 101 while the image sensing section 101 is being held in the normal posture and that has a portion that shows an authentication site. The “illuminance” is illuminance at an authentication site or in the vicinity of an authentication site. In a case where, for instance, the authentication site is an eye of the user's, the illuminance may be illuminance at a cheek of the user's and a site near the cheek. Such a site is not likely to be hidden by eye glasses or the like, and thus allows illuminance to be measured relatively accurately.

Embodiment 1 is a case where the biometric authentication device 100 is a smartphone as a specific example. A smartphone may include an in-camera for capturing an image of the user looking at the display screen and an out-camera for capturing an image on the opposite side. The image sensing section 101 described above is an in-camera. The display section 107 can be caused to display an image within the range of image capture by the image sensing section 101 as an in-camera. The user can thus capture an image after aligning the biometric authentication device 100 and an authentication site (eye) with each other in such a manner that the display section 107 displays the authentication site.

In a case where the biometric authentication device 100 is a smartphone, the “normal posture” refers to a posture in which the user normally uses the biometric authentication device 100 for a browser, a game, or the like, and to the most natural posture for the user to use the biometric authentication device 100. The “normal posture” can be described on the basis of the distance between the image sensing section 101 of the biometric authentication device 100 and an authentication site (in Embodiment 1, an eye of the user's). In the normal posture, the distance between the image sensing section 101 of the biometric authentication device 100 and an authentication site (eye) is approximately 20 cm to approximately 40 cm. In a case where the user captures an image of the face of the user's with use of the image sensing section 101 of the biometric authentication device 100 in the normal posture, it is typically possible to obtain a biometric authentication image that covers the face substantially entirely. The normal posture simply needs to be a posture which corresponds to, for example, the outer size and/or purpose of the biometric authentication device 100 and in which the user holds the biometric authentication device 100 naturally. The normal posture may be a posture other than the above.

Further, in the case where the biometric authentication device 100 is a smartphone, the “special posture” refers to a posture of the user holding the biometric authentication device 100 in a state where the biometric authentication device 100 is closer to an authentication site (eye) than in the normal posture. The user basically does not change to a special posture during normal use of the biometric authentication device 100, and changes to a special posture for authentication as necessary.

As illustrated in FIG. 2, in step S101, the image obtaining section 102 first causes the image sensing section 101 to capture an illuminance calculation image for use in illuminance value calculation. During this step, the user holds the biometric authentication device 100 in the normal posture. The image sensing section 101 of the biometric authentication device 100 is thus held in the normal posture as well. The illuminance calculation image captured by the image sensing section 101 is stored in the storage section 108.

Next, in step S102, the illuminance calculating section 103 calculates an illuminance value from the illuminance calculation image obtained by the image obtaining section 102. The “illuminance value” detected by the illuminance calculating section 103 from the illuminance calculation image is an index for determining whether it is possible to capture a biometric authentication image having a definition that allows authentication. The illuminance value is, for example, the energy of light (unit: lux (lx)) that is received by a unit area of a surface of the authentication site over a unit time period.

The illuminance calculating section 103 converts image information on the illuminance calculation image into illuminance information to calculate an illuminance value. The illuminance calculating section 103 can convert image information on an illuminance calculation image into illuminance information by, for example, converting the Y value (luminance value) of the YUV format, which is typically used as an image format, into illuminance. However, a typical camera adjusts the brightness gain and/or the exposure time period for a captured image to have a suitable brightness. For instance, a camera can adjust an image captured in a somewhat dark place so that the image will have a brightness equivalent to that of a bright place. Thus, in step S102, the illuminance calculating section 103 carries out illuminance conversion while factoring in, for example, the brightness gain and/or the exposure time period. In other words, in S102, the illuminance calculating section 103 calculates the illuminance that was achieved before the brightness of the illuminance calculation image was adjusted. Many smartphones each include a built-in optical sensor (not shown). The optical sensor detects illuminance not of the authentication site but of the optical sensor portion of the smartphone. Thus, such illuminance may be used as illuminance of an area surrounding the authentication site so that the illuminance information calculated by the illuminance calculating section 103 is complemented with the illuminance of the surrounding area. The illuminance value calculated by the illuminance calculating section 103 is stored in the storage section 108 in association with the illuminance calculation image. Alternatively, the illuminance detected by the optical sensor may be used as image sensing environment information related to image sensing so that whether it is possible to capture a biometric authentication image having a definition that allows authentication is determined on the basis of the illuminance value detected by the optical sensor.

Next, the authentication image size deciding section 104 determines in step S103 whether authentication is possible in the normal posture. Specifically, the authentication image size deciding section 104 determines on the basis of the illuminance value calculated in step S102 by the illuminance calculating section 103 whether authentication is possible with use of a biometric authentication image captured in the normal posture under an illuminance condition indicated by the illuminance value. Authentication in this example is possible in a bright environment in the normal posture (in an environment such as a living room of the user's house or an office (each of which is considered as having a high use frequency)). The authentication image size deciding section 104 determines in a dark place that authentication is impossible because it is impossible to obtain information sufficient for authentication from a captured image.

The determination in step S103 may be carried out with reference to a comparison table that shows how the illuminance value corresponds to whether authentication is possible with a necessary accuracy. Such a comparison table may be created by (i) capturing a biometric authentication image in various illuminance environments while changing the distance between the image sensing section 101 and the authentication site and (ii) actually checking whether authentication is possible with use of the biometric authentication image captured. The comparison table may, for example, be a table that shows a lower limit of the image size of the eye width with which image size authentication is possible (the size of the eye portion in the biometric authentication image) for each illuminance range (for example, 0 to 10 lux and 10 lux to 30 lux). The lower limit is large in a case where the illuminance is low, and is small in a case where the illuminance is high. There is, for example, an individual difference in the eye size and/or whether authentication is possible. The comparison table is thus preferably created by determining, from the measurement value of the eye size of each of a plurality of persons, the average eye size and whether authentication is possible. The comparison table is stored in, for example, the storage section 108 in advance.

FIG. 9 is an example of a comparison table that shows a correspondence between the illuminance range, the number of pixels for the eye width with which number authentication is possible, and the size of the guide image. The example comparison table in FIG. 9 defines, for example, respective illuminance ranges of not less than 0 lux and less than 10 lux, not less than 10 lux and less than 30 lux, and not less than 30 lux and less than 100 lux. Each of these illuminance ranges corresponds to “one eye” as the guide image size. In other words, the comparison table in FIG. 9 indicates that within any of the illuminance ranges, authentication is impossible in a case where an image is to be captured in the normal posture, in which both eyes are within the image sensing range. Thus, the authentication image size deciding section 104 may, in a case where the illuminance value calculated in step S102 is, for example, within the range of not less than 0 lux and less than 10 lux, determine that authentication in the normal posture is impossible.

The illuminance range of not less than 100 lux corresponds to “both eyes” as the guide image size. In other words, the comparison table in FIG. 9 indicates that within these illuminance ranges, authentication is possible in a case where an image is to be captured in the normal posture, in which both eyes are within the image sensing range. Thus, the authentication image size deciding section 104 may, in a case where the illuminance value calculated in step S102 is within the range of not less than 100 lux, determine that authentication in the normal posture is possible.

If the authentication image size deciding section 104 has determined in step S103 that authentication is possible, the process goes on to step S104. In step S104, the authentication image size deciding section 104 decides on an image size necessary for authentication in the normal posture. The “image size” refers to the range of the eye portion as an authentication site in the biometric authentication image, and may be a range expressed in pixels, for example. The image size can be specified with reference to the comparison table described above. In a case where, for instance, the comparison table in FIG. 9 shows the illuminance range of not less than 100 lux as corresponding to 200 pixels as the number of pixels for the eye width as a lower limit, the authentication image size deciding section 104 decides that the image size of the eye which image size is necessary for authentication is, for example, 250 pixels (width)×125 pixels (height) to capture an image in which the eye width is not less than 200 pixels. The image size may be a size that allows both eyes of the user's to be included in a biometric authentication image (that is, an image size that allows an image to be captured in the normal posture).

If the authentication image size deciding section 104 has determined in step S103 that authentication is impossible, the process goes on to step S105. In step S105, the authentication image size deciding section 104 decides on an image size necessary for authentication in the special posture. In a case where, for instance, the comparison table in FIG. 9 shows the number of pixels of 750 pixels for the eye width as a lower limit as corresponding to the illuminance range of less than 10 lux, the authentication image size deciding section 104 decides that the image size necessary for authentication is, for example, 800 pixels (width)×400 pixels (height) to capture an image in which the eye width is not less than 750 pixels. The image size may be a size that allows only one eye of the user's to be included in a biometric authentication image (that is, an image size that allows an image to be captured in the special posture).

As illustrated in FIG. 9, the comparison table may be arranged such that for the illuminance range of less than 100 lux (which requires authentication in the special posture), illuminance ranges are set in stages (for example, not less than 0 lux and less than 10 lux, not less than 10 lux and less than 30 lux, and not less than 30 lux and less than 100 lux), and for each illuminance range, a lower limit is associated with an image size of the eye width which image size allows authentication (for example, pixels of the eye width) so that the image size necessary for authentication is set in stages in accordance with the illuminance. This makes it possible to set, in stages in accordance with the illuminance, the distance between the image sensing section 101 and an authentication site in a case where the authentication image size deciding section 104 has determined that authentication is impossible in the normal posture. Thus, in a case where, for instance, the illuminance is slightly insufficient as compared to illuminance that allows authentication in the normal posture, the above configuration makes it possible to show a guide image having a size that requires the image sensing section 101 and an authentication site to be closer to each other only a little as compared to the distance for a case of the normal posture. In a dark place, the above configuration makes it possible to show a guide image having a size that requires the image sensing section 101 and an authentication site to be as close to each other as possible.

In step S106, the guide image selecting section 105 (i) selects, from among guide images having respective sizes different from one another, a single guide image in accordance with the image size that the authentication image size deciding section 104 has decided on in step S104 or S105, and (ii) causes the display section 107 to display the guide image selected.

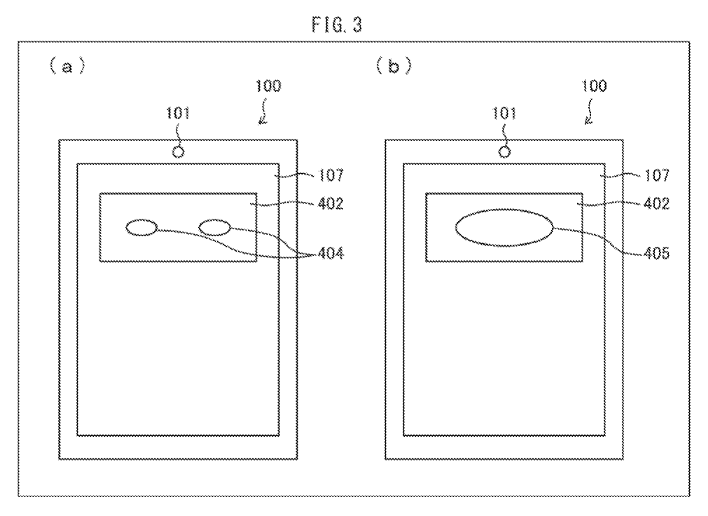

FIG. 3 provides diagrams each as an example output image of the biometric authentication device 100 in accordance with Embodiment 1 of the present invention. (a) of FIG. 3 illustrates an output image including a guide image (first guide image) 404 for aligning an authentication site and the image sensing section 101 with each other in the normal posture. (b) of FIG. 3 illustrates an output image including a guide image (second guide image) 405 for aligning an authentication site and the image sensing section 101 with each other in the special posture.

In a case where the process has gone from step S104 to step S106, the guide image selecting section 105 selects the guide image 404 illustrated in (a) of FIG. 3 and causes the display section 107 to display the guide image 404 selected.

In a case where the process has gone from step S105 to step S106, the guide image selecting section 105 selects the guide image 405 illustrated in (b) of FIG. 3 and causes the display section 107 to display the guide image 405 selected. The guide images 404 and 405 are each an elliptical image corresponding to the outer shape of the user's eyes. The size of the ellipse(s) is larger for the guide image 405. More specifically, the ellipses of the guide image 404 have a size corresponding to the image size that the authentication image size deciding section 104 has decided on in step S104. The ellipse of the guide image 405 has a size corresponding to the image size that the authentication image size deciding section 104 has decided on in step S105. The guide image 404 includes ellipses corresponding respectively to both eyes. The guide image 404 prompts the user to capture an authentication image in the normal posture, that is, with the eyes so apart from the image sensing section 101 that an image of both eyes is captured. The guide image 405 prompts the user to capture a larger image of the eyes than for the guide image 404 (that is, to capture an authentication image in the special posture, in which the eyes are close to the image sensing section 101).

As illustrated in FIG. 3, the guide image 404 or 405 may be superimposed on an authentication preview image 402 displayed by the display section 107. The authentication preview image 402 is an image that has been captured by the image sensing section 101 and that allows the user to see the image capturing target of the image sensing section 101. This makes it easy for the user to, in step S107 later, adjust the distance between the image sensing section 101 and an authentication site while seeing (i) the authentication preview image 402 displayed by the display section 107 and (ii) the guide image 404 or 405 superimposed on the authentication preview image 402 to align the authentication site and the image sensing section 101 with each other.

A camera has the following typical properties:
(i) Capturing an image of an object with the object closer to the camera allows more detailed information of the object to be obtained. (This assumes that the level of the focus is not less than a certain level. A function such as an autofocus function may be used.)
(ii) A brighter environment allows more detailed information of the object to be obtained.

The guide image 404, which is displayed in a case where the authentication image size deciding section 104 has determined that authentication is possible in the normal posture, allows an authentication site and the image sensing section 101 to be aligned with each other in the normal posture as well. The guide image 405, which is displayed in a case where the authentication image size deciding section 104 has determined that authentication is impossible in the normal posture, allows an authentication site and the image sensing section 101 to be aligned with each other in the special posture. The guide image 405 thus has a region for the user to enclose the user's eyes which region is larger than that for the guide image 404. In a case where the user aligns an authentication site and the image sensing section 101 with each other with use of the guide image 405, the user brings the authentication site and the image sensing section 101 closer to each other so that the authentication site shows with a larger size in the authentication preview image 402. In an environment with insufficient illuminance, the user utilizes the property (i) above to obtain a biometric authentication image having a definition necessary for authentication. Further, when displaying the authentication preview image 402, the display section 107 serves as a light source as well. Bringing an authentication site and the image sensing section 101 closer to each other causes the display section 107 to be closer to the authentication site, with the result of the illuminance of the authentication site being larger. This indicates that the user also utilizes the property (ii) above at the same time.

The kind of guide image for aligning an authentication site and the image sensing section 101 with each other in the special posture is not limited to only one, that is, the guide image 405 (second guide image). As described above, the image size necessary for authentication in the special posture may be set in stages (n stages, where n is a natural number of 1 or greater) in accordance with the illuminance. There may thus be n or more kinds (where n is a natural number of 1 or greater) of guide images for aligning an authentication site and the image sensing section 101 with each other in the special posture in accordance with the image size that the authentication image size deciding section 104 has decided on. In other words, a plurality of guide images for aligning an authentication site and the image sensing section 101 with each other in the special posture simply need to include at least a second guide image for aligning an authentication site and the image sensing section 101 with each other at such respective positions that the distance between the authentication site and the image sensing section 101 is smaller than that for use in the alignment with use of the first guide image. Further, the plurality of guide image may include a third guide image, a fourth guide image, . . . and an n-th guide image for aligning an authentication site and the image sensing section 101 with each other at such respective positions that the distance between the authentication site and the image sensing section 101 is smaller in stages (n stages, where n is a natural number of 1 or greater) than that for use in the alignment with use of the second guide image.

The respective sizes of guide images may be varied in no stages according to the image sensing environment information. This is because this case also involves displayed guide images that at least include (i) a first guide image and (ii) a second guide image for aligning an authentication site and the image sensing section 101 with each other at such respective positions that the distance between the authentication site and the image sensing section 101 is smaller than that for the alignment with use of the first guide image.

In step S107, the guide image selecting section 105 causes the image sensing section 101 to capture a biometric authentication image while keeping the display section 107 displaying an authentication preview image 402 on which the guide image 404 or 405 selected is superimposed. The biometric authentication section 106 then detects an eye portion of the biometric authentication image captured. The guide image selecting section 105 causes the image sensing section 101 to capture a biometric authentication image in a state where an alignment has been carried out between the eye portion of the guide image 404 or 405 and the eyes of the user's in the authentication preview image 402. The biometric authentication section 106 may thus detect a region in the biometric authentication image which region corresponds to the eye portion of the guide image 404 or 405.

In step S108, the biometric authentication section 106 tries to match the eye portion detected in step S106 with a preregistered image of the user's eyes for an authentication process. Specifically, the biometric authentication section 106 extracts features from a vein in the white of the eyes in the detected portion, and tries to match the features extracted with the features of the white of the user's eyes in the preregistered image for authentication. If the biometric authentication section 106 has been successful in the matching, authentication has succeeded, and the process ends there. If the biometric authentication section 106 has been unsuccessful in the matching, authentication has failed, and the process ends there.

As described above, the biometric authentication device 100 in accordance with Embodiment 1 eliminates the need for the user to bring an authentication site of the body of the user's near the camera in a case where the user is to capture a biometric authentication image in a bright place. The user thus simply needs to bring an authentication site near the camera only when it is necessary to do so (specifically, only in a case where the user is to capture a biometric authentication image in a dark place). Thus, unlike conventional art, the biometric authentication device 100 does not require the user to change the posture greatly from the posture in which the user normally operates the portable terminal. This in turn prevents the usability from decreasing as a result of the user changing the posture each time of authentication, and allows a highly reliable authentication process to be carried out.

(3) Variation of Biometric Authentication Device 100

The storage section 108, the display section 107, and the image sensing section 101 may each be a unit separate from and external to the biometric authentication device 100. The image sensing section 101 and the display section 107, however, preferably have a positional relationship that allows the user to align the image sensing section 101 and an authentication site with each other while seeing a captured image displayed by the display section 107 and a guide image superimposed on the captured image.

Variation of Biometric Authentication Technique

The illuminance condition should be similar for face authentication, iris authentication, and the like. Thus, even in a case where the biometric authentication device 100 carries out face authentication, iris authentication, or the like as another example biometric authentication technique in place of eye-white authentication, the biometric authentication device 100 produces an effect similar to the effect produced when eye-white authentication is carried out. In a case where the biometric authentication device 100 carries out face authentication as another example biometric authentication technique in place of eye-white authentication, the authentication site will be the entire face of the user's. In a case where the biometric authentication device 100 carries out iris authentication, the authentication site will be the iris of the user's.

Variation of Eye-White Authentication

In a case where the biometric authentication device 100 carries out eye-white authentication, the biometric authentication device 100 can carry out authentication through matching of both eyes, right eye only, or left eye only.

Variation of Shape and Size of Guide Image

The guide images that the guide image selecting section 105 causes the display section 107 to display for the biometric authentication device 100 are not limited to the guide images 404 and 405 illustrated in FIG. 3. The size and shape of each guide image may be varied as appropriate, as long as the guide image allows the user to capture an image having an image size not smaller than the lower limit of the image size of the eye width which image size is associated with an illuminance range and which image size allows authentication.

FIG. 9 shows an example in which in a case where the illuminance is less than 100 lux (which requires authentication in the special posture), the image size necessary for authentication is set in stages according to the illuminance. The comparison table may alternatively be arranged to include two illuminance ranges, namely, (i) an illuminance range of not less than 100 lux, which allows authentication in the normal posture, and (ii) an illuminance range of less than 100 lux (that is, not less than 0 lux and less than 100 lux), which requires authentication in the special posture, and to associate the illuminance range (ii) above with the number of pixels of 750 pixels for the eye width as a lower limit.

Variation of Method for Displaying Guide Image

FIG. 3 shows an example in which an authentication preview image 402 is displayed in only a partial region of the display section 107. The size of the region of the display section 107 in which region an authentication preview image 402 is displayed is, however, not limited to such a size. An authentication preview image 402 may be displayed in, for example, the entire display region of the display section 107. FIG. 3 shows an example in which an authentication preview image 402 is displayed at an upper central portion of the display region of the display section 107. The position on the display section 107 at which position an authentication preview image 402 is displayed is, however, not limited to such a position. An authentication preview image 402 may be displayed at, for example, a lower portion of the display region of the display section 107. With respect to the left-right position on the display section 107, an authentication preview image 402 may be displayed to the left or right from the center of the display section 107 in FIG. 3. To obtain a biometric authentication image of the front of the face of the user when the user is seeing in the front direction, an authentication preview image 402 is preferably (i) of an area as small as possible, for instance, of only the authentication site and its vicinity and (ii) displayed at a position close to the image sensing section 101. This prevents the direction in which the user sees the authentication preview image 402 from being deviated greatly from the position of the image sensing section 101, and thereby makes it possible to obtain a biometric authentication image of the front of the user's face.

### Embodiment 2

The following description will specifically discuss, with reference to drawings, a biometric authentication device 200 in accordance with Embodiment 2 of the present invention. Any element of the present embodiment that is similar to an element described for the above embodiment(s) is assigned the same reference sign, and is not described again here. This applies to Embodiment 3 as well.

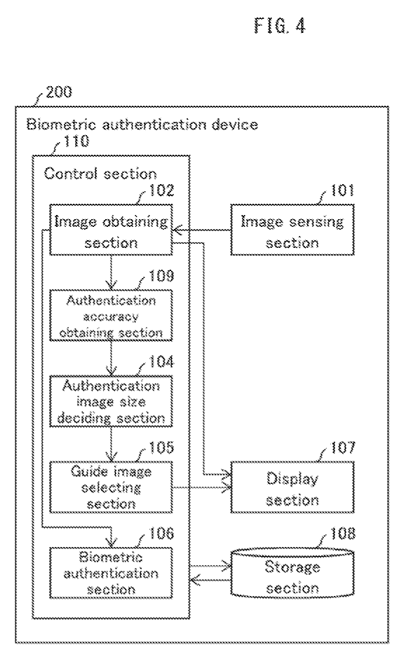

FIG. 4 is a block diagram illustrating the functional configuration of a biometric authentication device 200 in accordance with Embodiment 2 of the present invention. The biometric authentication device 200 is a biometric authentication device for carrying out authentication with use of a biometric authentication image captured of a portion of a living body as an authentication site. The biometric authentication device 200 includes an image sensing section 101, a display section 107, a storage section 108, and a control section 110.

The biometric authentication device 200 differs from the biometric authentication device 100 of Embodiment 1 in that the control section 110 of the biometric authentication device 200 further includes an authentication accuracy obtaining section 109 and does not include the illuminance calculating section 103. A later description will detail a process related to the authentication accuracy obtaining section 109.

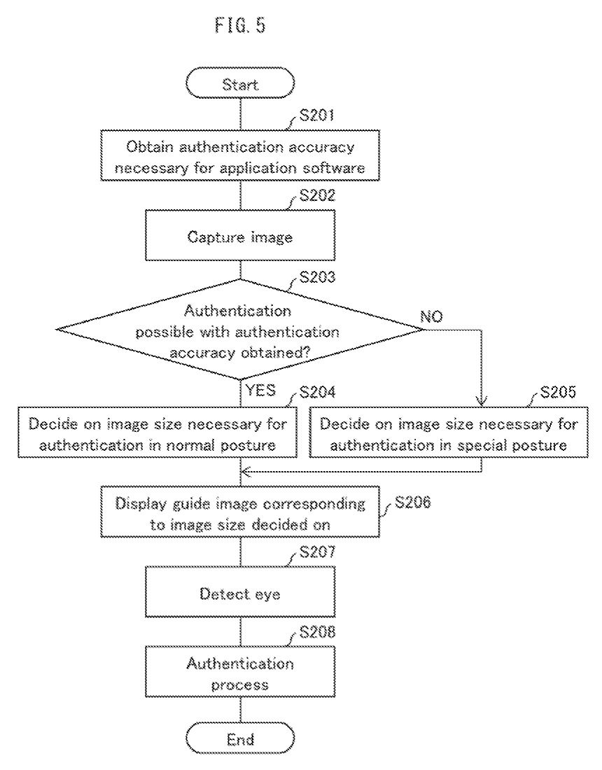

The following description will discuss, with reference to FIG. 5, an example biometric authentication process carried out by the biometric authentication device 200. FIG. 5 is a flowchart illustrating a process carried out by the biometric authentication device 200 in accordance with Embodiment 2 of the present invention. Embodiment 2 involves an example in which whether it is possible to capture a biometric authentication image having a definition that allows authentication is determined on the basis of the authentication accuracy required by application software.

The “application software” refers to application software that runs on the biometric authentication device 200 in accordance with the result of biometric authentication. The description below deals with such examples of the application software as (i) application software for managing locking of the biometric authentication device 200 (hereinafter referred to as “locking app”), (ii) application software (such as a telephone book app and a diary app; hereinafter referred to as “personal information protecting app”) having the function of protecting particular personal information (personal information such as a telephone book and a diary), and (iii) application software for bank settlements (hereinafter referred to as “banking app”). The locking app unlocks the biometric authentication device 200 if biometric authentication has been successful to set the biometric authentication device 200 to a state that allows the user to operate the biometric authentication device 200. The personal information protecting app unprotects particular information if biometric authentication has been successful to set the biometric authentication device 200 to a state that allows the user to view the information. The banking app carries out a payment process if biometric authentication has been successful. The banking app, which is directly related to transaction of money and the like, requires a higher authentication accuracy than the locking app or personal information protecting app.

As illustrated in FIG. 5, in step S201, the authentication accuracy obtaining section 109 first obtains information on the authentication accuracy necessary for the application software intended to be executed. The authentication accuracy may be preset for each application program. This allows the authentication accuracy obtaining section 109 to, by identifying application software to be operated in accordance with the authentication result, specify the authentication accuracy necessary for the application software. The authentication accuracy may be represented by information that indicates the level of required authentication accuracy in stages such as high, middle, and low. The description below assumes that the authentication accuracy for the banking app is “high”, the authentication accuracy for the personal information protecting app is “middle”, and the authentication accuracy for the locking app is “low”. The authentication accuracy set for each application program is, however, not limited to the above. The user may alternatively set as appropriate an authentication accuracy for each application program in accordance with the user's intention.

In step S202, the image obtaining section 102 causes the image sensing section 101 to capture a determination image for use in determining whether authentication is possible. During this step, the user holds the biometric authentication device 100 in the normal posture. The image sensing section 101 of the biometric authentication device 100 is thus held in the normal posture as well. The determination image captured by the image sensing section 101 is stored in the storage section 108.

In step S203, the authentication image size deciding section 104 determines whether authentication is possible in the normal posture with the authentication accuracy on which information has been obtained in step S201 (whether it is possible to, in the normal posture, capture a biometric authentication image having a definition that allows authentication). Specifically, the authentication image size deciding section 104 determines whether authentication is possible with the required accuracy with use of the determination image obtained in step S202.

The determination in step S203 may be carried out with reference to a comparison table that shows how the authentication accuracy corresponds to whether authentication is possible with a necessary accuracy. Such a comparison table may be created by (i) capturing a biometric authentication image in a certain illuminance environment with various authentication accuracies while changing the distance between the image sensing section 101 and the authentication site and (ii) actually checking whether authentication is possible with use of the biometric authentication image captured. The comparison table may, for example, be a table that shows, for each authentication accuracy, a lower limit of the image size of the eye with which image size authentication is possible. The lower limit is large in a case where the authentication accuracy is high, and is small in a case where the authentication accuracy is low. There is, for example, an individual difference in the eye size and/or whether authentication is possible. The comparison table is thus preferably created by determining, from the measurement value of the eye size of each of a plurality of persons, the average eye size and whether authentication is possible. The comparison table is stored in, for example, the storage section 108 in advance.

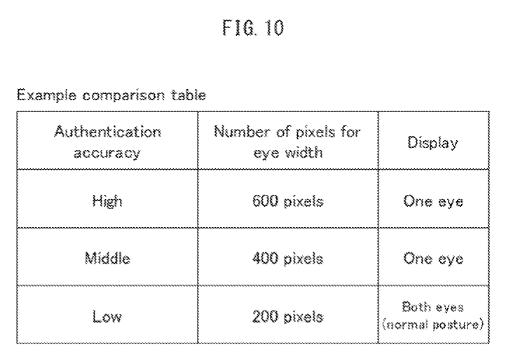

FIG. 10 is an example of a comparison table that shows a correspondence between the authentication accuracy, the number of pixels for the eye width with which number authentication is possible, and the size of the guide image displayed. In a case where, for instance, the comparison table in FIG. 10 defines a low authentication accuracy, a high authentication accuracy, and the like, the authentication image size deciding section 104 may determine if the authentication accuracy on which information has been obtained in step S201 is “low” that authentication is possible in the normal posture, and if the authentication accuracy on which information has been obtained in step S201 is “high”, determine that authentication is impossible in the normal posture. This allows the authentication image size deciding section 104 to determine even if the illuminance around the authentication site is the same that authentication is impossible for the banking app and possible for the locking app.

Embodiment 2 is an example involving a comparison table created in a certain illuminance environment. However, different comparison tables may be created in different illuminance environments to factor in an illuminance condition. This will be described later for Embodiment 3.

If the authentication image size deciding section 104 has determined in step S203 that authentication is possible, the process goes on to step S204. In step S204, the authentication image size deciding section 104 decides on an image size necessary for authentication in the normal posture. The image size can be specified with reference to the comparison table described above. In a case where, for instance, the comparison table shows 200 pixels as corresponding to the “low” authentication accuracy, the authentication image size deciding section 104 decides that the image size of the eye which image size is necessary for authentication is, for example, 250 pixels (width)×125 pixels (height) to capture an image in which the eye width is not less than 200 pixels. The image size may be a size that allows both eyes of the user's to be included in a biometric authentication image (that is, an image size that allows an image to be captured in the normal posture).

If the authentication image size deciding section 104 has determined in step S203 that authentication is impossible, the process goes on to step S205. In step S205, the authentication image size deciding section 104 decides on an image size necessary for authentication in the special posture. In a case where, for instance, the comparison table in FIG. 10 shows 600 pixels as corresponding to the “high” authentication accuracy, the authentication image size deciding section 104 decides that the image size necessary for authentication is, for example, 650 pixels (width)×325 pixels (height) to capture an image in which the eye width is not less than 600 pixels. The image size may be a size that allows only one eye of the user's to be included in a biometric authentication image (that is, an image size that allows an image to be captured in the special posture).

The comparison table may be arranged such that as illustrated in FIG. 10, (i) the authentication accuracy is set in stages (for example, “middle” and “high”) for each authentication accuracy other than “low” with which authentication accuracy authentication in the special posture is necessary and (ii) each authentication accuracy is associated with a lower limit of the image size of the eye width with which image size (for example, the number of pixels for the eye width) authentication is possible. This allows an image size necessary for authentication to be set in stages according to the authentication accuracy. This makes it possible to set, in stages in accordance with the authentication accuracy, the distance between the image sensing section 101 and an authentication site in a case where the authentication image size deciding section 104 has determined that authentication is impossible in the normal posture. Thus, in a case where, for instance, an authentication accuracy is required that is slightly higher (for example, “middle” authentication accuracy) than an authentication accuracy with which authentication in the normal posture is possible, the above configuration makes it possible to show a guide image having a size that requires the image sensing section 101 and an authentication site to be closer to each other only a little as compared to the distance for a case of the normal posture. In a case where an authentication accuracy is required that is even higher (such as an authentication accuracy necessary for a bank settlement), the above configuration makes it possible to show a guide image having a size that requires the image sensing section 101 and an authentication site to be as close to each other as possible.

Steps S206 to S208 are as described for steps S106 to S108 under “Embodiment 1” above.

As described above, the biometric authentication device 200 in accordance with Embodiment 2 eliminates the need for the user to bring an authentication site of the body of the user's near the camera in a case where the user is to run application software that does not require a high authentication accuracy. The user thus simply needs to bring an authentication site near the camera only when it is necessary to do so (specifically, only in a case where the user is to run application software that does require a high authentication accuracy). Thus, unlike conventional art, the biometric authentication device 100 does not require the user to change the posture greatly from the posture in which the user normally operates the portable terminal. This in turn prevents the usability from decreasing as a result of the user changing the posture each time of authentication, and allows an authentication process to be carried out with an authentication accuracy required by application software.

(3) Variation of Biometric Authentication Device 200

The variation of the biometric authentication device 100 described under “Embodiment 1” above is applicable to the biometric authentication device 200 as well.

Variation of Size of Guide Image

FIG. 10 shows an example in which the image size necessary for authentication is set in stages according to the authentication accuracy. The comparison table may alternatively be arranged to include two authentication accuracies, namely, (i) the “low” authentication accuracy, which allows authentication in the normal posture, and (ii) the “high” authentication accuracy, which requires authentication in the special posture, and to associate the authentication accuracy (ii) above with the number of pixels of 600 pixels for the eye width as a lower limit.

### Embodiment 3

The following description will specifically discuss, with reference to drawings, a biometric authentication device 300 in accordance with Embodiment 3 of the present invention.

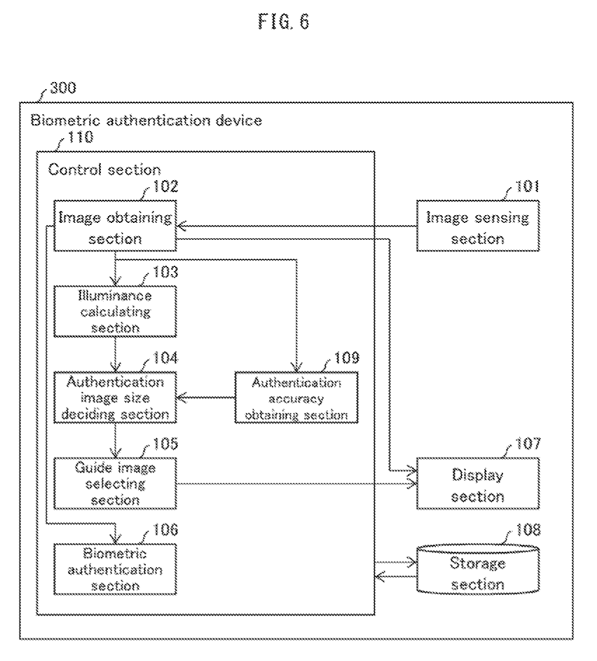

FIG. 6 is a block diagram illustrating the functional configuration of a biometric authentication device 300 in accordance with Embodiment 3 of the present invention. The biometric authentication device 300 is a biometric authentication device for carrying out authentication with use of a biometric authentication image captured of a portion of a living body as an authentication site. The biometric authentication device 300 includes an image sensing section 101, a display section 107, a storage section 108, and a control section 110.

The biometric authentication device 300 differs from the biometric authentication device 100 of Embodiment 1 and the biometric authentication device 200 of Embodiment 2 in that the control section 110 of the biometric authentication device 300 includes both the illuminance calculating section 103 and the authentication accuracy obtaining section 109.

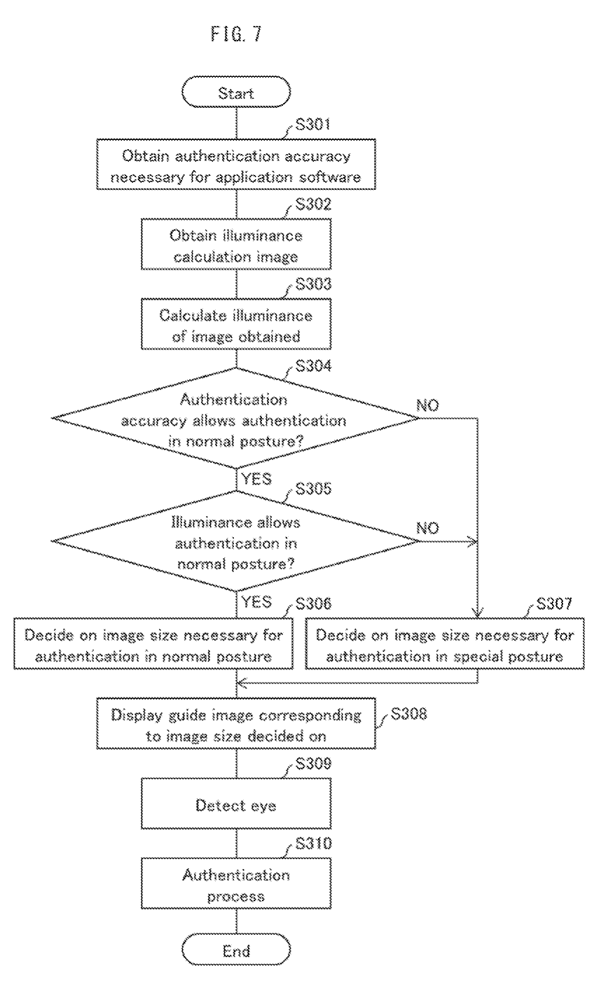

The following description will discuss, with reference to FIG. 7, an example biometric authentication process carried out by the biometric authentication device 300. FIG. 7 is a flowchart illustrating a process carried out by the biometric authentication device 300 in accordance with Embodiment 3 of the present invention. Embodiment 3 involves an example in which whether it is possible to capture a biometric authentication image having a definition that allows authentication is determined on the basis of both (i) the authentication accuracy required by application software and (ii) the illuminance value calculated from an illuminance calculation image (image sensing environment information related to image sensing).

The biometric authentication device 300 carries out a biometric authentication process that combines (i) the biometric authentication process carried out by the biometric authentication device 100 of Embodiment 1 and (ii) the biometric authentication process carried out by the biometric authentication device 200 of Embodiment 2.

As illustrated in FIG. 7, in step S301, the authentication accuracy obtaining section 109 first obtains information on the authentication accuracy necessary for the application software to be executed. Step S301 is as described for step S201 under “Embodiment 2” above.

Next, in step S302, the image obtaining section 102 first causes the image sensing section 101 to capture an illuminance calculation image for use in illuminance calculation. Step S302 is as described for step S101 under “Embodiment 1” above.

Next, in step S303, the illuminance calculating section 103 calculates an illuminance value of an authentication site from the illuminance calculation image obtained by the image obtaining section 102. Step S303 is as described for step S102 under “Embodiment 1” above.

Next, in step S304, the authentication image size deciding section 104 determines whether authentication is possible in the normal posture with the authentication accuracy on which information has been obtained in step S301 (whether it is possible to capture a biometric authentication image having a definition that allows authentication with an accuracy required by the application software). Step S304 is as described for step S203 under “Embodiment 2” above.

If the authentication image size deciding section 104 has determined in step S304 that authentication is possible, the process goes on to step S305. If the authentication image size deciding section 104 has determined in step S304 that authentication is impossible, the process goes on to step S307.

In step S305, the authentication image size deciding section 104 determines on the basis of the illuminance value calculated in step S303 by the illuminance calculating section 103 whether authentication is possible with use of a biometric authentication image captured in the normal posture under an illuminance condition indicated by the illuminance value. The authentication image size deciding section 104, in other words, determines in terms of the illuminance value whether it is possible to, in the normal posture, capture a biometric authentication image having a definition that allows authentication. Step S305 is as described for step S103 under “Embodiment 1” above.

If the authentication image size deciding section 104 has determined in step S305 that authentication is possible, the process goes on to step S306. If the authentication image size deciding section 104 has determined in step S305 that authentication is impossible, the process goes on to step S307.

If the authentication image size deciding section 104 has determined in steps S304 and S305 that authentication is possible, and the process goes on to step S306, the authentication image size deciding section 104 decides in step S306 on an image size necessary for authentication in the normal posture. Step S306 is as described for step S104 under “Embodiment 1” above.

If the authentication image size deciding section 104 has determined in step S304 or S305 that authentication is impossible, the authentication image size deciding section 104 decides in step S307 on an image size necessary for authentication in the special posture. Step S307 is as described for step S105 under “Embodiment 1” above and for step S205 under “Embodiment 2” above.

Steps S308 to S310 are as described for steps S106 to S108 under “Embodiment 1” above.

As described above, the biometric authentication device 300 in accordance with Embodiment 3 eliminates the need for the user to bring an authentication site of the body of the user's near the camera in a case where the user is to run application software that does not require a high authentication accuracy and is to capture a biometric authentication image in a bright place. The user thus simply needs to bring an authentication site near the camera only when it is necessary to do so (specifically, only in a case where the user is to run application software that does not require a high authentication accuracy but is to capture a biometric authentication image in a dark place or a case where the user is to run application software that does require a high authentication accuracy). Thus, unlike conventional art, the biometric authentication device 300 does not require the user to change the posture greatly from the posture in which the user normally operates the portable terminal. This in turn prevents the usability from decreasing as a result of the user changing the posture each time of authentication, and allows an authentication process to be carried out with an authentication accuracy required by application software.

(3) Variation of Biometric Authentication Device 300

The variation of the biometric authentication device 100 described under “Embodiment 1” above and the variation of the biometric authentication device 200 described under “Embodiment 2” above are applicable to the biometric authentication device 300 as well.

Variation of Order of Steps S304 and S305

The description above has dealt with an example in which step 304 (determining step based on the authentication accuracy) is followed by step S305 (determining step based on the illuminance). This may be varied such that step 305 (determining step based on the illuminance) is carried out first and is followed by step S304 (determining step based on the authentication accuracy) carried out on the basis of the result of the preceding determination.

Example Hardware Configuration

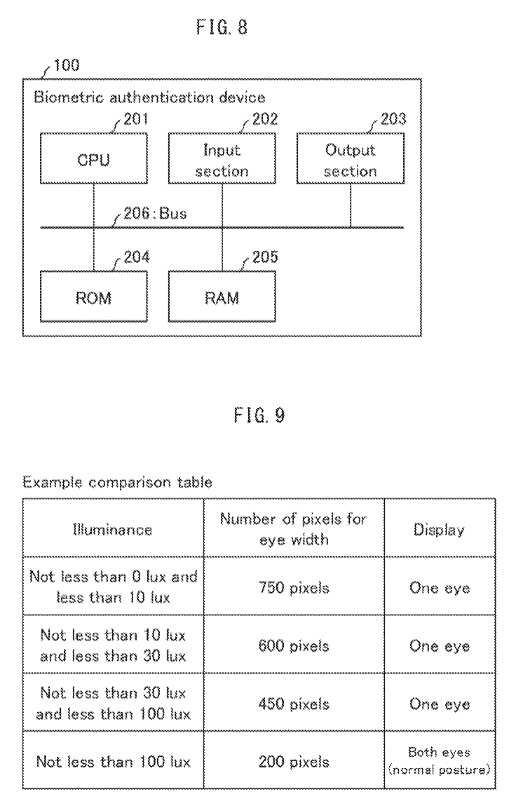

The biometric authentication device 100 described above may have, for example, a hardware configuration illustrated in FIG. 8. FIG. 8 is a block diagram illustrating an example hardware configuration of the biometric authentication device 100. The biometric authentication device 100 in FIG. 8 is a computer including a central processing unit (CPU) 201, an input section 202, an output section 203, a read-only memory (ROM) 204, and a random access memory (RAM) 205, which are connected to one another over a bus 206. The input section 202 includes the image sensing section 101. The output section 203 includes the display section 107. The RAM 205 stores, for example, data on (i) images captured by the image sensing section 101 and (ii) the illuminance value calculated by the illuminance calculating section 103. The ROM stores, for example, a comparison table. The ROM 204 further stores various programs for causing the biometric authentication device 100 to operate. The CPU 201 loads the programs from the ROM 204 onto the RAM 205 and executes instructions included in the programs. This allows the individual functions of the control section 110 to be achieved, thereby causing the computer to function as the biometric authentication device 100. The storage medium storing information such as information for a program simply needs to be a computer-readable, non-transitory tangible medium such as a tape, a disk, a card, a semiconductor memory, and a programmable logic circuit.

The program may be obtained from outside the biometric authentication device 100. In this case, the program may be obtained via any transmission medium (such as a communication network or a broadcast wave). The present invention can also be achieved in the form of a data signal in which the program is embodied via electronic transmission and which is embedded in a carrier wave. Further, control blocks of the biometric authentication device 100 (individual sections included in the control section 110) can be realized by a logic circuit (hardware) provided in an integrated circuit (IC chip) or the like. This applies similarly to the biometric authentication devices 200 and 300.

[Recap]

A biometric authentication device (100, 200, 300) in accordance with a first aspect of the present invention includes: an image sensing section (101) configured to capture a biometric authentication image of a part of a living body; a display section (107) configured to display a guide image among a plurality of guide images for aligning the part of the living body and the image sensing section (101) with each other in order for the image sensing section (101) to capture the biometric authentication image; and a control section (110) configured to carry out authentication on a basis of the biometric authentication image, the control section (110) being configured to cause the display section to display one of the plurality of guide images on a basis of at least either (i) an authentication accuracy corresponding to application software configured to operate in accordance with a result of the authentication or (ii) image sensing environment information related to the capturing, the plurality of guide images at least including (i) a first guide image (guide image 404) for aligning the part of the living body and the image sensing section (101) with each other at such respective positions that the part of the living body and the image sensing section (101) are separated from each other by a first distance and (ii) a second guide image (guide image 405) for aligning the part of the living body and the image sensing section (101) with each other at such respective positions that the part of the living body and the image sensing section (101) are separated from each other by a second distance smaller than the first distance.

The above configuration allows the user to (i) in a case where authentication is possible in the normal posture, carry out alignment in the current posture on the basis of the first guide image to capture a biometric authentication image for authentication and (ii) in a case where authentication is impossible in the normal posture, change the posture to the special posture, carry out alignment on the basis of the second guide image, and capture a biometric authentication image for authentication. This allows the user to change the holding posture only when it is necessary to do so, and thereby improves the usability during biometric authentication over conventional art.

A biometric authentication device (100, 200, 300) in accordance with a second aspect of the present invention is configured as in the first aspect and may be further configured such that the image sensing environment information is information based on illuminance of (i) the part of the living body or (ii) an area surrounding the part of the living body, the part of the living body and the area appearing in the biometric authentication image.

With the above configuration, the image sensing environment information is information based on illuminance of (i) the part of the living body or (ii) an area surrounding the part of the living body, the part of the living body and the area appearing in the biometric authentication image. The biometric authentication image captured reflects the image sensing environment. This makes it possible to display a suitable guide image according to the image sensing environment.

A biometric authentication device (100, 200, 300) in accordance with a third aspect of the present invention is configured as in the first or second aspect and may further include: an optical sensor configured to measure illuminance of an area around the optical sensor, wherein the image sensing environment information is information based on the illuminance measured by the optical sensor.

With the above configuration, the image sensing environment information is illuminance detected by an optical sensor. The illuminance detected by the optical sensor is information indicative of the image sensing environment. This makes it possible to display a suitable guide image according to the image sensing environment.

A biometric authentication device (100, 300) in accordance with a fourth aspect of the present invention is configured as in any of the first to third aspects and may be further configured such that the control section (110) is configured to cause the display section (107) to display one of the plurality of guide images on a basis of both (i) the authentication accuracy and (ii) the image sensing environment information.

The above configuration allows the user to change the posture to the special posture, carry out alignment, and capture a biometric authentication image for authentication only when it is necessary to do so, in accordance with the authentication accuracy required by application software to be executed and image sensing environment information related to image sensing. This allows the user to change the holding posture only when it is necessary to do so, and thereby improves the usability during biometric authentication over conventional art.

A control program in accordance with a fifth aspect of the present invention is a biometric authentication program for causing a computer to function as a control section (110) defined for the first aspect. This configuration produces an effect similar to that produced with the first aspect.

A biometric authentication method in accordance with a sixth aspect of the present invention includes the steps of: causing an image sensing section to capture a biometric authentication image of a part of a living body; causing a display section to display one of a plurality of guide images on a basis of at least either (i) an authentication accuracy corresponding to application software configured to operate in accordance with a result of authentication or (ii) image sensing environment information related to the capturing; and carrying out authentication on a basis of the biometric authentication image, the plurality of guide images at least including (i) a first guide image for aligning the part of the living body and the image sensing section with each other at such respective positions that the part of the living body and the image sensing section are separated from each other by a first distance and (ii) a second guide image for aligning the part of the living body and the image sensing section with each other at such respective positions that the part of the living body and the image sensing section are separated from each other by a second distance smaller than the first distance. This configuration produces an effect similar to that produced with the first aspect.

The biometric authentication device according to the foregoing embodiments of the present invention may be realized by a computer. In this case, the present invention encompasses: (i) a biometric authentication program that causes a computer to carry out the above steps so that the biometric authentication device can be realized by the computer and (ii) a computer-readable storage medium storing the biometric authentication program thereon.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100, 200, 300 Biometric authentication device
101 Image sensing section
107 Display section
110 Control section
404 Guide image (first guide image)
405 Guide image (second guide image)

1. A biometric authentication device, comprising:
an image sensing section configured to capture a biometric authentication image of a part of a living body;
a display section configured to display a guide image among a plurality of guide images for aligning the part of the living body and the image sensing section with each other in order for the image sensing section to capture the biometric authentication image; and
a control section configured to carry out authentication on a basis of the biometric authentication image,
the control section being configured to cause the display section to display one of the plurality of guide images on a basis of at least either (i) an authentication accuracy corresponding to application software configured to operate in accordance with a result of the authentication or (ii) image sensing environment information related to the capturing,
the plurality of guide images at least including (i) a first guide image for aligning the part of the living body and the image sensing section with each other at such respective positions that the part of the living body and the image sensing section are separated from each other by a first distance and (ii) a second guide image for aligning the part of the living body and the image sensing section with each other at such respective positions that the part of the living body and the image sensing section are separated from each other by a second distance smaller than the first distance.

2. The biometric authentication device according to claim 1, wherein
the image sensing environment information is information based on illuminance of (i) the part of the living body or (ii) an area surrounding the part of the living body, the part of the living body and the area appearing in the biometric authentication image.

3. The biometric authentication device according to claim 1, further comprising:
an optical sensor configured to measure illuminance of an area around the optical sensor, wherein
the image sensing environment information is information based on the illuminance measured by the optical sensor.

4. The biometric authentication device according to claim 1, wherein
the control section is configured to cause the display section to display one of the plurality of guide images on a basis of both (i) the authentication accuracy and (ii) the image sensing environment information.

5. A computer-readable non-transitory recording medium on which a biometric authentication program for causing a computer to function as a control section recited in claim 1 is stored.

6. A biometric authentication method, comprising the steps of:
causing an image sensing section to capture a biometric authentication image of a part of a living body;
causing a display section to display one of a plurality of guide images on a basis of at least either (i) an authentication accuracy corresponding to application software configured to operate in accordance with a result of authentication or (ii) image sensing environment information related to the capturing; and
carrying out authentication on a basis of the biometric authentication image,
the plurality of guide images at least including (i) a first guide image for aligning the part of the living body and the image sensing section with each other at such respective positions that the part of the living body and the image sensing section are separated from each other by a first distance and (ii) a second guide image for aligning the part of the living body and the image sensing section with each other at such respective positions that the part of the living body and the image sensing section are separated from each other by a second distance smaller than the first distance.
